(19) United States
(12) Patent Application Publication
(10) Pub. No.: US 2026/0210762 A1
(43) Pub. Date: Jul. 23, 2026

(54) OPTICAL FREQUENCY DETECTOR BASED ON ON-CHIP REAL-TIME DETECTION OF OPTICAL FREQUENCY VARIATIONS WITH ULTRAHIGH RESOLUTION

(71) Applicant: Xiaotian Steve Yao, Las Vegas, NV (US)

(72) Inventor: Xiaotian Steve Yao, Las Vegas, NV (US)

(21) Appl. No.: 19/399,489

(22) Filed: Nov. 24, 2025

Related U.S. Application Data
(60) Provisional application No. 63/724,171, filed on Nov. 22, 2024.

(51) Int. Cl. G01J 3/18; G01J 3/45

(52) U.S. Cl. CPC G01J 3/1895; G01J 3/45

(57) ABSTRACT

This patent document discloses optical frequency detectors based on on-chip real-time detection of optical frequency variations with ultrahigh resolutions, including examples of such detectors using photonic integrated circuit (PIC) chips and the associated algorithm dedicated for measuring fast optical frequency variations (OFV).

### PRIORITY CLAIM AND RELATED PATENT APPLICATION

This patent document claims priority to, and benefits of, U.S. Provisional Application No. 63/724,171 entitled “OPTICAL FREQUENCY DETECTOR BASED ON ON-CHIP REAL-TIME DETECTION OF OPTICAL FREQUENCY VARIATIONS WITH ULTRAHIGH RESOLUTION” by Xiaotian Steve Yao filed on Nov. 22, 2025 (Attorney Docket No. 009095.8029.US00).

### TECHNICAL FIELD

This patent document relates to photonics integrated circuit devices capable of measuring optical frequency information of light and the uses of such devices in various applications including, among others, light detection and ranging (LiDAR) devices, optical sensing devices and systems.

### BACKGROUND

The measurement of the optical frequency of light can be used in various applications. In some applications, it can be important to precisely measure or obtain the optical frequency information with a high resolution and at a high speed. Examples of such applications include laser frequency control, laser frequency analysis, fiber Bragg grating interrogation, frequency trigger signals for optical coherence tomography, optical frequency domain reflectometry, and chirped Light Detection and Ranging (“LiDAR”) systems for collision prevention for autonomous driving vehicles.

### BRIEF DESCRIPTION OF DRAWINGS

FIG. 1 includes FIGS. 1A, 1B, 1C and 1D. FIG. 1A: The schematic drawing of the sine-cosine optical frequency detector (OFD) including two un-balanced I-Q interferometers with different free spectral ranges (FSRs). FIG. 1B Frequency or wavelength of a tunable laser varies rapidly with time. FIG. 1C Illustration of the signal output from one photodetector PD in the upper (main) interferometer with a small free spectral range FSR (blue) for high resolution detection of optical frequency variations (OFV), and one photodetector PD in the lower (assistive) interferometer with a large FSR (red) for low resolution absolution frequency detection. FIG. 1D Measured Δφᵤ(t) from Eq. (4) and the corresponding demodulated frequency or wavelength.

FIG. 2 shows an example of a testing setup for the calibration and evaluation of a photonic integrated circuit optical frequency detector PIC OFD.

FIG. 3 shows examples of measurements of a PIC OFD device and includes FIGS. 3A, 3B, 3C and 3D. FIG. 1A: OFD measurement results of the instantaneous wavelength of a tunable laser (Santec TSL-570) being scanned in a range from 1500 nm to 1630 nm having a period of 3.5 s, with the down ramp notably faster than the up ramp. FIG. 3B: the corresponding wavelength changing rates in different time windows. FIG. 3C: the OFD measurement results of the same laser being step-tuned, with the wavelength steps clearly shown. FIG. 3D: the expanded view of a single step, showing the wavelength transition following a sinusoidal function. A low cost DAQ card (60 kS/s and 16-bit resolution) is used in the measurements.

FIG. 4 includes FIGS. 4A and 4B, and shows examples of measured data from a PIC OFD device shown in FIG. 1A using the measurement setup in FIG. 2. FIG. 4A: Measurement data showing the wavelength scanning ripple, with three repeated measurements in three consecutive wavelength scanning cycles. FIG. 4B: The wavelength deviations of three repeated measurements from a linear fit, showing the details of the wavelength scanning ripples.

FIG. 5 includes FIGS. 5A, 5B, 5C and 5D, and shows measurements of high speed frequency scan and modulation measurement results. FIG. 5A: Measured instantaneous wavelength (frequency) of a high-speed tunable laser (Newport TLB-8800-HSH-CL) scanned at a rate of 20000 nm/s (~2500 THz/s). Inset: the zoom-in view of the data showing stairway-like frequency increments. FIG. 5B: The generated f-clock (k-clock) with a frequency increment of 0.5 GHz and a pulse width of 10 ns. FIG. 5C: The scan rate derived from FIG. 5A, with minor irregularities clearly shown. FIG. 5D: OFV (blue line) of a narrow linewidth fiber laser (NKT Photonics Basik E15) being sinusoidally modulated at 100 KHz and the corresponding scan rate (red line) obtained by taking the derivative of the OFV data showing that a frequency variation speed of over ±25 THz/s can be clearly measured. The data shown in FIG. 5D has been digitally filtered with a low pass filter (2nd order Butterworth with a cutoff frequency of 200 kHz) to remove excessive electronic noises.

FIG. 6 includes FIGS. 6A and 6B, and shows examples of measured data. FIG. 6A: The measured wavelength (frequency) as a laser (Yenista TUNICS T100S-HP) is step-tuned at 1 pm per step. FIG. 6B: The measured optical frequency variation when the frequency of a fiber laser (NKT Photonics BASIK E15) is modulated with a sinusoidal waveform at 1 Hz, with the data digitally filtered by a low pass filter (3^{rd} order Butterworth) having a cutoff frequency of 50 Hz (blue) and 5 Hz (red), respectively.

FIG. 7 includes FIGS. 7A, 7B, 7C and 7D, and shows an example of a PIC OFD device and measurements thereof as an example for demonstration of fiber Bragg grating (FBG) interrogation with PIC OFD. FIG. 7A: Experiment setup with a fiber Bragg grating (FBG) placed onto a self-made cantilever beam (inset). FIG. 7B: The measured dynamic strain showing the damped oscillation of the cantilever beam excited by tapping it with a fingertip, with the data filtered by a 3rd order Butterworth filter having a cutoff frequency of 100 Hz. Inset: expanded view of the data in the black box around 10 seconds. FIG. 7C: Details of the damped oscillation and the corresponding curve fit between 1 and 2 seconds. FIG. 7D: Measured dynamic strain induced by the acoustic wave from a speaker underneath the cantilever beam, with the data filtered by a 3rd order Butterworth filter having a cutoff frequency of 1 kHz.

FIG. 8 includes FIGS. 8A, 8B, 8C and 8D, and shows examples of applications based on on-chip OFDs. FIG. 8A: On-chip k-clock generation for different distributed optical sensing systems. FIG. 8B: Chip-sized multi-channel FBG interrogator; FIG. 8C: On-chip frequency monitoring and control of integrated lasers for frequency synthesizing and optical micro-ring resonators MRRs based optical computing for different optical wavelengths at the output of the MZM;⁸ FIG. 8D: For rapidly obtaining the laser wavelengths in TDLS systems.

FIG. 9 includes FIGS. 9A, 9B and 9C, and shows examples of PIC OFD devices. FIG. 9A: Micrographs of the TFLN sine-cosine OFD chip including two unbalanced I-Q interferometers; FIG. 9B: a bend-directional coupler; and FIG. 9C: a 90° hybrid made with a 2×4 multimode interferometer (MMI). Inset: photo of a packaged PIC OFD.

FIG. 10 includes FIGS. 10A and 10B, and shows examples of four output interference signals from the main I-Q interferometer when the tunable laser is tuned in the vicinity of 1519 nm (FIG. 10A) and the Lissajous figure of V′ᵤ₁(t) vs. V′ᵤ₃(t) and the elliptical fit (FIG. 10B).

FIG. 11 includes FIGS. 11A, 11B, 11C and 11D, and shows measurements of PIC OFD devices. FIG. 11A: Bᵤ₁ and mᵤ₁Bᵤ₁ vs. λ, FIG. 11B: αᵤ vs. λ, FIG. 11C: βᵤ vs. λ, and FIG. 11D: γᵤ vs. λ, all obtained from the elliptical fits of Lissajous figures of V′ᵤ₁(t) vs. V′ᵤ₃(t), V′ᵤ₂(t) vs. V′ᵤ₃(t), and V′ᵤ₁(t) vs. V′ᵤ₄(t) with λ at 1 nm increment. A Santec tunable laser (TSL-570) and a DAQ card (ART USB3133A, 16-bit resolution, 60 kS/s maximum sampling rate) are used for the calibration.

FIG. 12 includes FIGS. 12A and 12B, and shows measurements. FIG. 12A: Measured FSR vs. wavelength. FIG. 12B: Dispersion coefficient obtained using the data in FIG. 12A.

FIG. 13 includes FIGS. 13A and 13B, and shows calibration results of the lower interferometer. FIG. 13A Obtained Δφₗ as a function of λ using Eq. (5). FIG. 13B λ as a function of Δφₗ obtained from the data in FIG. 13A. The wavelength step in FIGS. 13A and 13B is 1 nm.3

FIG. 14 includes FIGS. 14A, 14B, 14C, 14D, 14E and 14F, and shows an example of a fabrication process of a sine-cosine OFD chip in several steps shown in FIGS. 14A through 14F.

### SUMMARY

This patent document discloses optical frequency detectors based on on-chip real-time detection of optical frequency variations with ultrahigh resolutions, including examples of such detectors using photonic integrated circuit (PIC) chips and the associated algorithm dedicated for measuring fast optical frequency variations (OFV).

In one implementation, the disclosed technology can be used to provide a device for measuring an optical frequency of light. Such a device includes a substrate fabricated to support an integrated optical frequency detector to receive input light for measuring an optical frequency of the received input light; a first optical interferometer formed on the substrate having two interfering optical arms and an input optical port to receive a first portion of the received input light at an input optical wavelength that is split into the two interfering optical arms and an output optical port to receive and combine light from the two interfering optical arms to produce two first optical output interferometer signals; a second optical interferometer formed on the substrate having two interfering optical arms and an input optical port to receive a second portion of the received input light which is split into the two interfering optical arms, and an output optical port to receive and combine light from the two interfering optical arms to produce two second output interferometer signals, wherein the second optical interferometer is structured to have a phase difference between the two interfering arms different from a phase difference between the two interfering arms of the first optical interferometer; and photodetectors formed on the substrate to detect output signals from the first and second optical interferometers to obtain signal variations as both a sine function of an optical frequency of the input light and a cosine function of the optical frequency of the input light. This device further includes circuitry coupled to receive the output signals from the first and second optical interferometers and configured to process the output signals from the first and second optical interferometers based on the sine and consine functions and additional information of hardware imperfections caused by fabrication of the integrated optical frequency detector by deviations from device designs to determine an optical frequency of the input light

In another implementation, the disclosed technology can provide a method for measuring an optical frequency of light to include using an integrated optical frequency detector formed on a substrate to measure an optical frequency of input light received by the detector. The detector includes a first optical interferometer formed on the substrate having two interfering optical arms and an input optical port to receive a first portion of input light at an input optical wavelength that is split into the two interfering optical arms and an output optical port to receive and combine light from the two interfering optical arms to produce two first optical output interferometer signals, and a second optical interferometer formed on the substrate having two interfering optical arms and an input optical port to receive a second portion of the input light which is split into the two interfering optical arms, and an output optical port to receive and combine light from the two interfering optical arms to produce two second output interferometer signals. The second optical interferometer is structured to have a phase difference between the two interfering arms different from a phase difference between the two interfering arms of the first optical interferometer. This method further includes detecting output signals from the first and second optical interferometers to obtain signal variations as both a sine function of an optical frequency of the input light and a cosine function of the optical frequency of the input light; and processing the output signals from the first and second optical interferometers based on the sine and cosine functions and additional information of hardware imperfections caused by fabrication of the integrated optical frequency detector by deviations from device designs to determine an optical frequency of the input light.

Optical frequency detectors based on the disclosed technology can be used to achieve a high frequency detection speed for input light with a change in frequency above 1000 THz/s (e.g., 2500 THz/s) and a frequency measurement resolution less than 10 MHz s (e.g., around 2 MHz) in a measurement range of more than 160 nm, which can be further improved with electronics of higher speed and lower noise.

For example, such a sine-cosine optical frequency detector (OFD) can be fabricated on the thin film lithium niobate (TFLN) platform with a size of only 5.5 mm×2.7 mm. All parameters relating to OFVs, such as frequency scanning waveform, speed, direction, range, nonlinearity, and ripple can be accurately quantified in real time over a wide wavelength range, due to the robust algorithm and calibration procedure that are designed to account for device imperfections. As an application example, demonstrated devices and measurements show that this PIC OFD can be used as a fiber Bragg grating (FBG) interrogator for sensing the strain and vibration, with a sensitivity and speed far exceeding existing FBG interrogators. The disclosed technology in this patent document opens a new avenue for the on-chip optical frequency detection and will be found attractive for applications involving the measurement of fast OFVs, including on-chip laser frequency control or locking, optical computing, optical frequency synthesizing, frequency modulated continuous wave (FMCW) LiDAR, optical frequency domain reflectometer (OFDR), optical coherence tomography (OCT), fiber Bragg grating (FBG) interrogation, and tunable diode laser spectroscopy (TDLS), among other applications.

The above and other features and their implementations are explained in more detail in the drawings, the description and the claims.

### DETAILED DESCRIPTION

Many optical distributed sensing applications, such as FMCW LiDAR and OFDR¹⁻³, require the measurement of fast optical frequency (wavelength) variations with high resolution for obtaining the k-clocks for data processing. Similarly, for FBG based quasi-distributed sensing applications, the ability for FBG interrogators to rapidly determine the wavelength variations of the reflected light from the sensing FBGs with high spectral resolution can greatly help to improve the performances of the system⁴. On the other hand, for optical computing involving micro-ring resonators (MRR) and wavelength division multiplexing (WDM)⁵⁻⁸, the real-time detection of optical frequency variations (OFV) with high resolution is attractive for the accurate control of each WDM channel's frequency for precisely adjusting the weights of the WDM channels. In addition, the frequency control and monitoring of on-chip narrow linewidth lasers⁹⁻¹² is also important for their intended applications. Unfortunately, the measurement speed and resolution of the traditional optical frequency or wavelength measurement devices, such as wavemeters¹³⁻¹⁷ and optical spectrum analyzers (OSAs)¹⁸ are generally not sufficient to meet such demanding applications, although they have exceptionally high wavelength measurement accuracies. In addition, the large size and high cost of these devices generally prohibit them from being included in the sensing and optical computing systems.

To overcome these issues, unbalanced Mach-Zehnder interferometers (UMZI) are often used in the distributed sensor systems to measure the optical frequency for getting the required f-clock or k-clock^{2,3}. The output signal of the UMZI is proportional to sin [Δφ(t)+φ₀], where Δφ(t)=2πτΔf(t) is the phase induced by the OFV Δf(t), τ is the time delay corresponding to the optical path delay (OPD) between the two interferometer arms, and φ₀ is a constant phase. By measuring the phase Δφ(t), the optical frequency variation (OFV) can be obtained, with a resolution inversely proportional to the time delay τ. In practice, zero-crossings of the UMZI signal are used to determine the OFV with a resolution equaling to one half of the free spectral range (FSR) of the UMZI. Therefore, a very long length of optical fiber, up to few hundred or even thousand meters, must be used in the UMZI for the required OPD to get sufficient measurement resolution, which prevents the scheme being implemented on a photonic integrated circuit (PIC) chip. In addition, as discussed in¹⁹, the long OPD enlarges the contribution of the laser frequency (or phase) noises in the interference signal, causing errors in the f-clock generations. Furthermore, the laser frequency scan ripples around the zero crossings of the UMZI output signal can also cause large frequency measurement errors^{19,20}. Finally, the large OPD makes the speed of the interference signal corresponding to the OFV very high, which significantly increases the cost and power consumption of the electronic circuitry and therefore the cost of the detection system.

Hilbert transform of the UMZI output signal can be used to obtain the cosine function of the phase term Δφ(t), which can be used together with the sine function of Δφ(t) to determine the OFVs with much higher resolution and therefore can significantly reduce the required OPD in the UMZI²¹. Unfortunately, the process is not real time because a long length of Δφ(t) data must be taken first before performing the Hilbert transform. Therefore, such a method is not suited for obtaining real-time k-clock or control signals in frequency stabilization and sensor applications that requires measuring the OFVs in real time, although it has been used for compensating the frequency scan nonlinearity of the tunable laser used in the system during post data processing^{2,3,22}.

To measure the OFVs in real time with high frequency resolution, several sine-cosine techniques have been proposed and demonstrated^{19,23-25}. The basic idea is to simultaneously get the sine and cosine functions of Δφ(t) induced by the OFVs, similar in principle to the sine-cosine encoder commonly used in electrical motors to determine the rotation angle increments^{26,27}. In the implementation, only a very short OPD, on the order of 1 mm, is required for achieving an optical frequency resolution on the order of 10 MHz, sufficient for most applications¹⁹. Unfortunately, the demonstrated sine-cosine optical frequency detectors (OFD) were implemented with birefringence crystals or discrete optical components, which are too large to be integrated on a photonic chip.

Integrated chip-scale wavemeters have been successfully demonstrated using different types of unbalanced interferometers^{28,29} similar in principle to the sine-cosine techniques, however, these devices are intended for high accuracy wavelength measurement and therefore most attention has been paid to the compensation of the thermal drift of the waveguides. Almost no efforts are made towards the detection of the detailed dynamics of the optical frequency variations with high speed and high resolution.

In this patent document, examples of OFD devices are disclosed to demonstrate the first realization of a sine-cosine OFD implemented on a PIC chip for measuring rapid OFV, with a robust demodulation formulism to account for device imperfections in a wide wavelength range from 1480 to 1640 nm. Optical paths on the PIC chip can be implemented with optical waveguides formed the PIC chip. In particular, the thin film lithium niobate (TFLN) platform is used to implement the OFD for convenience, although other material platforms, such as SOI and SiN, can also be used. The resulting sine-cosine OFD chip measures only 5.5 mm×2.7 mm, which can detect OFV with a demonstrated resolution down to 2 MHz (0.016 μm) and a speed up above 1000 TH/s (e.g., around 2500 TH/s), limited by the noise and speed of certain electronics but already sufficient for most applications. This patent document shows that the OFV resolution on the order of 0.5 MHz with a speed of 3×10⁴ THz/s can be achieved with a fabricated OFD chip using commercially available electronics of 1 MHz detection bandwidth. In addition, the required speed of the electronic circuit is reduced thousands of times compared to the UMZM approach described previously, resulting in large cost savings. The disclosed PIC OFD technology can be used to deternube tunable lasers' frequency scanning waveforms, nonlinearity, irregularity, speed, range, direction, and even tuning ripples that may not detectable with other measurement methods or devices. The disclosed PIC OFD technology can be used to form a FBG interrogator with a strain measurement resolution of 0.1~0.2με at 500 Hz. A strain resolution of 0.013με and a temperature resolution of 0.0015° C. at a measurement bandwidth of 5 Hz are expected from the achievable OFV resolution of 2 MHz (0.016 μm), which is about 20 times better than the best FBG interrogators on the market. Pairing better commercially available electronics with the PIC OFD, 80 times better resolutions than those of the best commercial FBG interrogators can also be achieved. The disclosed sine-cosine PIC OFD with the associated demodulation algorithm validates a new approach for the sensing PIC design and can be incorporated in different chip scale interrogators for various distributed and quasi-distributed sensing applications, as well as for on-chip laser frequency control and stabilization³⁰, which can be used for microring resonator (MRR) based optical computing schemes⁸, among others.

### Example of On-Chip Optical Frequency Detector (OFD)

### Scheme and Principle

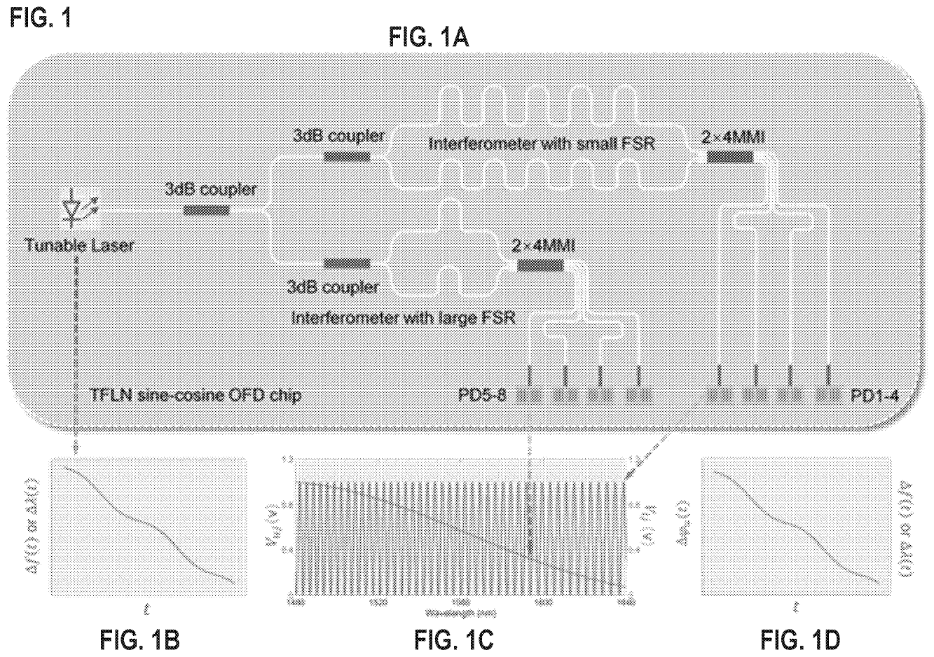

FIG. 1A illustrates the configuration of the proposed sine-cosine OFD. The light from a tunable laser with rapid frequency variation, as shown in FIG. 1B, is first split into two branches by a 50% coupler, one of which goes to an upper unbalanced interferometer (the main interferometer) and the other goes to a lower unbalanced interferometer (the assistive interferometer). Each interferometer includes a 1×2 coupler and a 90° hybrid with two input ports and four output ports³¹, with the upper one having a large optical path difference OPD (or a small free spectral range FSR) between the two arms for high resolution frequency increment measurement, while the lower one having a small OPD, corresponding to a very large FSR, to ensure the output signal is monotonic in the whole wavelength (or frequency) measurement range of the OFD for estimating the absolute wavelength of light, as shown in FIG. 1C.

In some implementations, each 90° hybrid is made with a 2×4 multimode interference (MMI) coupler³¹, although other types of 90° hybrid can also be implemented³²⁻³⁶. The eight output ports of the two MMI couplers are attached with eight photodetectors (PD) labeled PD1 through PD8 for detecting the corresponding optical powers Pᵢ(t) (i=1, 2 . . . 8) and then converting them to eight voltages via eight transimpedance amplifiers (TIA). The four outputs in each interferometer can be grouped into two pairs. Ideally, the two interference signals in each pair are 180° out of phase, while the phase difference between the two pairs is 90°. Therefore, one pair of outputs is often called cosine channels (in-phase channels or I-channels), while the other pair is called sine channels (quadrature channels or Q-channels). That is why the scheme is called sine-cosine scheme, or alternatively, I-Q scheme. For simplicity, we may call the interferometers in FIG. 1 unbalanced I-Q interferometers.

In practice, the phase difference between the two signals in each pair is not perfectly 180°, and between the two pairs is not perfectly 90°. Therefore, the four output photovoltages Vᵤⱼ (j=1, 2, 3, 4) from the upper (main) interferometer can be expressed in general as:

$${V}_{u 1} ( t ) = {A}_{u 1} + {B}_{u 1} ( λ ) \{ 1 + {m}_{u 1} cos [ {Δφ}_{u} ( t ) - \frac{{α}_{u} ( λ )}{2} ] \} \qquad ( 1 a )$$

$${V}_{u 2} ( t ) = {A}_{u 2} + {B}_{u 2} ( λ ) \{ 1 - {m}_{u 2} cos [ {Δφ}_{u} ( t ) + \frac{{α}_{u} ( λ )}{2} ] \} \qquad ( 1 b )$$

$${V}_{u 3} ( t ) = {A}_{u 3} + {B}_{u 3} ( λ ) \{ 1 + {m}_{u 3} sin [ {Δφ}_{u} ( t ) + {γ}_{u} ( λ ) - \frac{{β}_{u} ( λ )}{2} ] \} \qquad ( 1 c )$$

$${V}_{u 4} ( t ) = {A}_{u 4} + {B}_{u 4} ( λ ) \{ 1 - {m}_{u 4} sin [ {Δφ}_{u} ( t ) + {γ}_{u} ( λ ) + \frac{{β}_{u} ( λ )}{2} ] \} \qquad ( 1 d )$$

where the subscript “u” stands for the upper interferometer, Aᵤⱼ are the voltage bias due to the imperfection of the electronic circuit for each channel, Bᵤⱼ are the amplitudes of the sine and cosine functions relating to the received optical power in each channel which are weakly wavelength dependent, mᵤⱼ are the modulation depth of each channel, and αᵤ, βᵤ, γᵤ are the phase imperfections of the 90° hybrid, which are also weakly wavelength dependent in general and are zero if the 90° hybrid is perfect. Finally, Δφᵤ(t) is the phase induced by the OFV Δf(t) and can be expressed as:

$${Δφ}_{u} ( t ) = 2 πΔ f ( t ) {τ}_{u} = \frac{2 πΔ f ( t )}{{FSR}_{u}} = \frac{2 πΔ f ( t )}{c / Δ {L}_{u}} \qquad ( 2 )$$

In Eq. (2), c is the speed of light, τᵤ is the time delay between the two arms of the upper I-Q interferometer, ΔLᵤ is the corresponding OPD, and FSRᵤ is the corresponding free spectral range, which are related by the following expression:

$$F S {R}_{u} = 1 / {τ}_{u} = c / Δ {L}_{u} \qquad ( 3 )$$

Note that FSRᵤ(or τᵤ) may vary with wavelength due to dispersion. In practice, FSRᵤ as a function of A can be accurately obtained with a tunable laser by measuring the periodicities of the sinusoidal interference signals of Eq. (1) when the wavelength of the laser is tuned, as shown in Supplementary Information Section.

Similar expressions can also be obtained for the lower I-Q interferometer by simply replacing the subscript “u” with “l” in Eqs. (1) and (2), where “l” stands for the lower interferometer.

If the 90° hybrid is perfect, αᵤ=βᵤ=γᵤ=0. However, in practice, these parameters are non-zero and wavelength dependent. In such non-ideal situations, a calibration procedure must be performed first to obtain these non-zero parameters, including Bᵤⱼ and mᵤⱼ, as a function of wavelength, which can be tabulated in a lookup table containing (Bᵤⱼ, mᵤⱼ, αᵤ, βᵤ, γᵤ) vs. λ, in addition to FSRᵤ vs. λ, as will be described in detail in Supplementary Information Section. Once these parameters are determined, the phase increment Δφᵤ(t) and the corresponding frequency increment Δf(t) can be obtained from Eq. (1) as

$$cos [ {Δφ}_{u} ( t ) ] = \frac{{v}_{u 1} ( t ) - {v}_{u 2} ( t )}{2 cos \frac{{α}_{u}}{2}} \qquad ( 4 a )$$

$$sin [ {Δφ}_{u} ( t ) + {γ}_{u} ] = \frac{{v}_{u 3} ( t ) - {v}_{u 4} ( t )}{2 cos \frac{{β}_{u}}{2}} \qquad ( 4 b )$$

$$( 4 c )$$

$$Δ f ( t ) = \frac{1}{2 π {τ}_{u}} {Δφ}_{u} ( t ) = \frac{1}{2 π {τ}_{u}} {tan}^{- 1} \{ \frac{[ {v}_{u 3} ( t ) - {v}_{u 4} ( t ) ] cos \frac{{α}_{u}}{2} - [ {v}_{u 1} ( t ) - {v}_{u 2} ( t ) ] cos \frac{{β}_{u}}{2} sin {γ}_{u}}{[ {v}_{u 1} ( t ) - {v}_{u 2} ( t ) ] cos \frac{{β}_{u}}{2} cos {γ}_{u}} \}$$

where vᵤⱼ=[Vᵤⱼ(t)−Aᵤⱼ−Bᵤⱼ]/(mᵤⱼBᵤⱼ) (j=1, 2, 3, 4) are normalized voltages with the circuit bias Aᵤⱼ and the interferometer DC term Bᵤⱼ subtracted. Like the sine-cosine motor encoder, the direction of the frequency variation can also be determined¹⁹, which allows the unwrapping of phase changes over 2π. Note that because all the device imperfections have been considered in Eq. (4c), the formula is extremely robust against design and fabrication tolerances, which ensures the feasibility for the mass deployment of the scheme in real world applications. The obtained Δφᵤ (t) and the corresponding Δf(t) is depicted in FIG. 1D.

Note that the upper interferometer by itself can only measure the incremental frequency, not the absolute frequency because of the multiple periodic cycles of the output signal corresponding to the OFVs in the measurement range. To estimate the absolute frequency or wavelength, the lower interferometer can be used, because the large FSR assures a single value output in the intended measurement range, as shown in FIG. 1. Like Eq. (4), the phase Δφₗ(λ) in the lower unbalanced I-Q interferometer corresponding to a wavelength λ can be written as:

$${Δφ}_{l} ( λ ) = {tan}^{- 1} \{ \frac{[ {v}_{l 3} ( λ ) - {v}_{l 4} ( λ ) ] cos \frac{{α}_{l}}{2} [ {v}_{l 1} ( λ ) - {v}_{l 2} ( λ ) ] cos \frac{{β}_{l}}{2} sin {γ}_{l}}{[ {v}_{l 1} ( λ ) - {v}_{l 2} ( λ ) ] cos \frac{{β}_{l}}{2} cos {γ}_{l}} \} \qquad ( 5 )$$

where vₗⱼ=[Vₗⱼ(t)−Aₗⱼ−Bₗⱼ]/(mₗⱼBₗⱼ) (j=1, 2, 3, 4) are normalized voltages with the circuit bias Aₗⱼ and the interferometer DC term Bₗⱼ subtracted, αₗ, βₗ, γₗ are the phase imperfections of the 90° hybrid in the lower interferometer. One may use a desk-top tunable laser with precisely known wavelengths to calibrate the output of the lower interferometer by relating Δφₗ(λ) obtained using Eq. (5) with the wavelength of the tunable laser, and then store the results of Δφₗ vs. λ in a lookup table. This way, at the start of optical frequency or wavelength measurement, the absolute frequency f₀ or wavelength λ₀ can be determined once Δφₗ is calculated from the four outputs of the lower interferometer. Combining with Eq. (4c), one gets:

$$f ( t ) = {f}_{0} + Δ f ( t ) \qquad ( 6 )$$

Perhaps more importantly, the lookup table of Δφₗ vs. λ can be used for determining λ for the selection of the wavelength dependent parameters in the lookup table of (Bᵤⱼ, mᵤⱼ, αᵤ, βᵤ, γᵤ, FSRᵤ) vs. λ for calculating Δf(t) with Eq. (4c), which will be discussed in more details in Supplementary Information Section.

Note that corresponding to an OFV, the signal variation speeds from the four output channels in the upper interferometer are η times faster than those from the lower interferometer, where m is their FSR ratio

$$( η = \frac{F S {R}_{l}}{F S {R}_{u}} ) .$$

Therefore, the TIAs and the DAQ card for the lower interferometer can be n times slower than those for the upper interferometer for significantly reduced cost, although in most of conducted experiments, the channels of the DAQ card had the same speed of 60 kS/s.

### Device Calibration

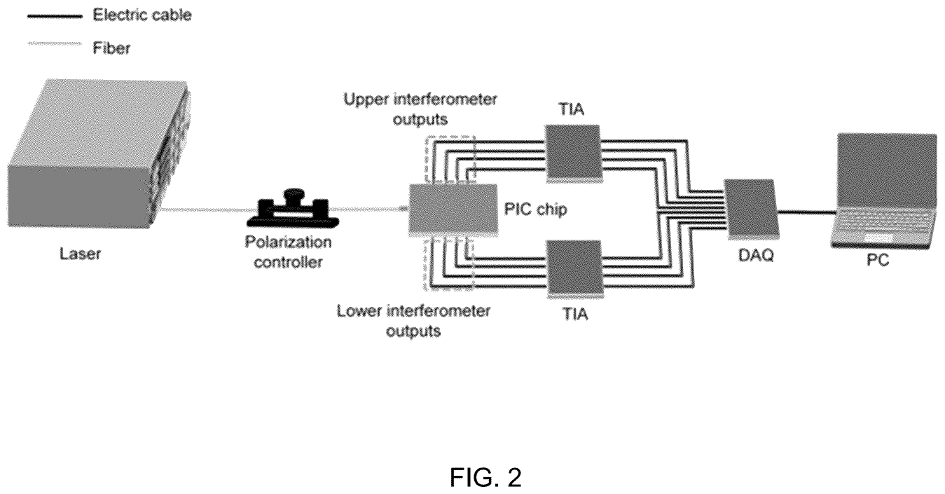

Many parameters of the fabricated device, such as Bᵤⱼ, mᵤⱼ, αᵤ, βᵤ, γᵤ, FSRᵤ, are wavelength dependent and need to be calibrated. The setup for the calibration and evaluation of the PIC OFD is shown in FIG. 2, in which a laser with wide wavelength tuning capability is used as the light source to input into the OFD chip via a polarization controller to align the input polarization to that of the TE mode of the chip. The eight light outputs of the chip are detected by the corresponding PDs and are converted to eight voltages by two 4-channel transimpedance amplifiers (TIA, Koheron TIA 400-2k, 10 MHz bandwidth, 4 channels each) before being digitized by an 8-channel DAQ card (60 kS/s with 16-bit resolution) and sent to a personal computer. The details of the calibration process and the results are included in Supplementary Information Section.

### Complete Characterization of Wavelength Scan Parameters of a Tunable Laser

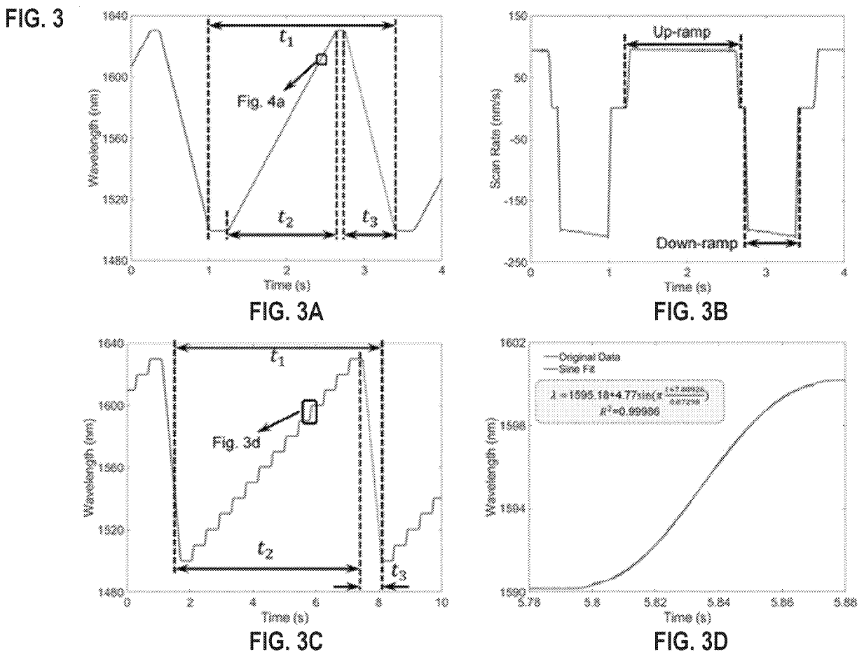

FIG. 3A shows the instantaneous wavelength of a tunable laser (Santec TSL-570) undergoing periodic scan (setting at 100 nm/s) in a range from 1500 nm to 1630 nm, measured with a disclosed PIC OFD after the calibration described in 4.1 is performed. Clearly, the directions of the wavelength (frequency) variations can be unmistakenly identified, with the up-ramp and down-ramp of the linear wavelength scan clearly shown, which can be fitted to λᵤₚ=−0.72t²+96.63t+1380 and λ_{down}=−9.13t²−146.08t+2101, both having an excellent goodness of fit R²=0.99999. The scan periodicity t₁, and the time windows for the up and down ramps t₂ and t₃ are obtained to be 2.394s, 1.43s, and 0.68s, respectively. The coefficient of the linear term represents the linear scan rate of the wavelength, showing that the down ramp is notably faster than the up ramp (191.18 nm/s vs. 90.91 nm/s). The scan rates in different time periods are shown in FIG. 3B, which are obtained by taking the derivative of the data in FIG. 3A. Note that there exist slight wavelength scan nonlinearities in the up and down ramps, represented by the coefficients of the quadratic terms of the fitted formula above, with the up ramp about 10 times smaller than that of the down ramp (−0.72 nm/s² vs. −9.13 nm/s²), which can also be seen in FIG. 3B.

FIG. 3C shows the measurement result when the laser is step-tuned at 10 nm per step, with the detail of each step clearly captured. The expanded view of each step is shown in FIG. 3D, with the transition between two steps following a sinusoidal function.

### Characterization of Wavelength Scan Ripples and Repeatability

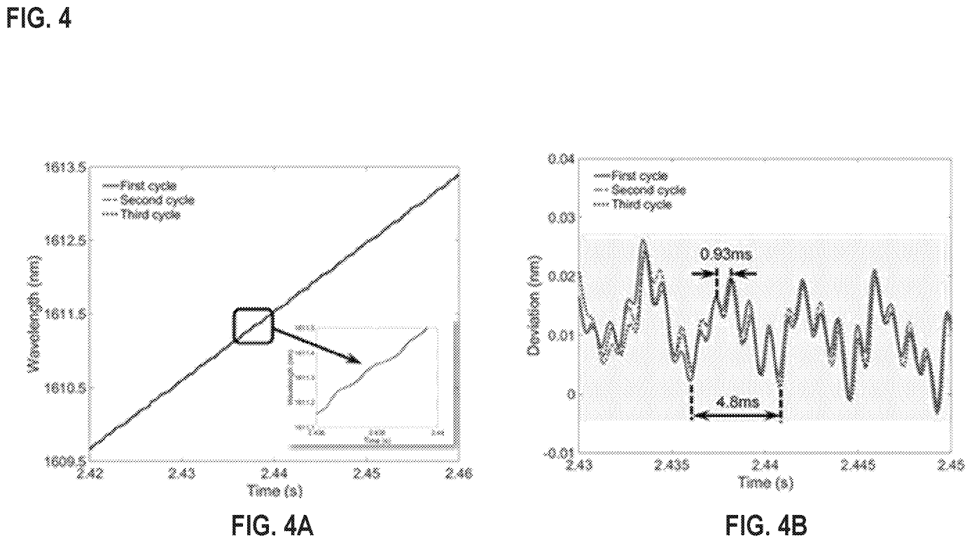

Because of the high wavelength (frequency) resolution of the disclosed PIC OFD, the details of the wavelength variations of a tunable laser can now be seen, which otherwise are not even known to exist by the laser manufacturers. FIG. 4A shows the zoom-in view of a small section of measured wavelength scan shown in the small box of FIG. 3A, in which small wavelength scanning ripples can be clearly seen. To rule out the possibility that the ripples are due to the measurement uncertainties, three repeated measurements were taken in three consecutive cycles of the wavelength scan. The highly repeatable results indicate that these ripples are indeed from laser scanning, not the measurement artifact. To further show the details of the scanning ripples, the deviations of the instantaneous wavelength from the linear fit curve of the wavelength up ramp are calculated and shown in FIG. 4B, which indicate that the ripples have a certain periodic pattern with a large periodicity of 4.8 ms and sub-periodicity of 0.93 ms, possibly due to the imperfections of the wavelength tuning mechanism, such as the motor or gears used for wavelength tuning.

### High-Speed OFV Measurements

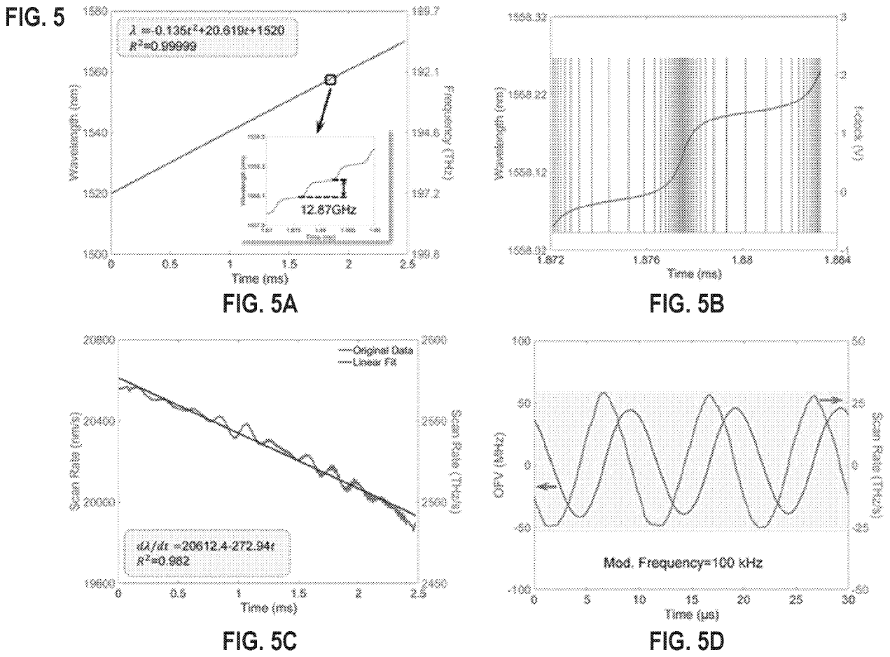

FIG. 5A shows the measured optical frequency of a rapidly tunable external cavity laser (Newport TLB-8800-HSH-CL) scanned at the highest rate of 20000 nm/s (2500 THz/s) with data acquired at a rate of 62.5 MS/s with two digital oscilloscopes (Rohde & Schwarz RTB2004, 10 bit resolution, 4 channels each), while the inset shows the zoom-in view of the data in the black box, revealing the details of the stairway-like frequency increments as a function of time. The disclosed PIC OFD is capable of measuring such high-speed frequency sweeps and the details of the OFV dynamics, which possibly reflects the effect of the step-motor based laser tuning mechanism f-clock (or k-clock) can be generated from the OFV data in FIG. 5A by digitally outputting pulses with a frequency increment of user's choice, as shown in FIG. 5B, in which a frequency increment of 0.5 GHz is chosen to faithfully represent the local OFV rate. FIG. 5C is the wavelength scan rate derived from the data in FIG. 5A, which shows that it deviates from the setting rate of 20000 nm/s and fluctuates at different times during the scan. Such a deviation is identified as the laser tuning imperfections, not the measurement artifacts, which can be characterized in detail by the disclosed PIC OFD.

To further validate the high-speed frequency measurement capability of the disclosed PIC OFD, we sinusoidally modulate the frequency of a narrow linewidth laser (NKT Photonics Basik E15, 1550.12 nm, 16.2 dBm output power) with a modulation depth setting of 100% at a rate of 100 kHz using the laser's built-in frequency modulation function and measure the corresponding OFV with the disclosed PIC OFD. The results are shown by the blue curve in FIG. 5D, which can be further used to obtain the rate of the OFV by taking the derivative of the data, as shown by the red curve in FIG. 5D. It is evident that the disclosed PIC OFD can provide detailed information on the rapidly varying optical frequency and its variation rate.

### High-Resolution OFV Measurements

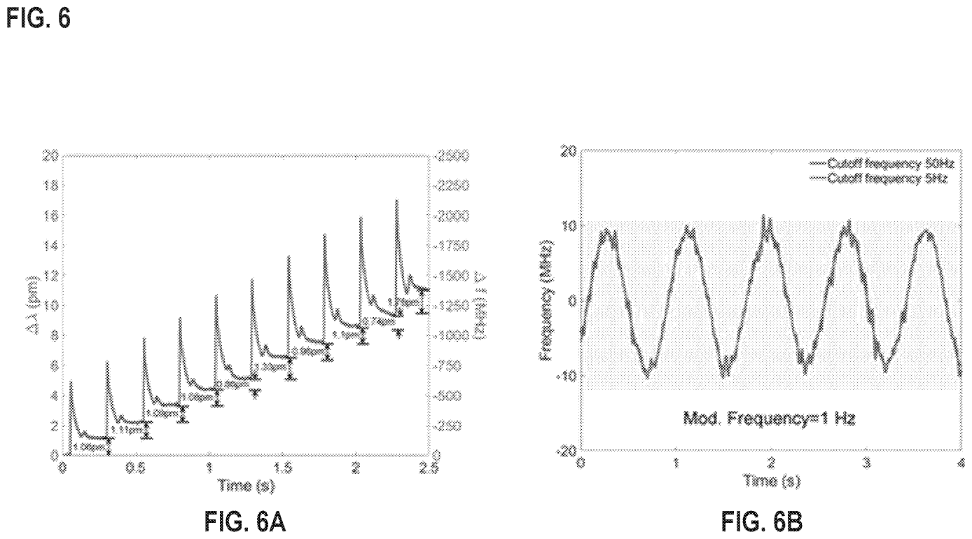

To demonstrate the fine detail measurement capability of the disclosed PIC OFD, a tunable laser fine-tuned with the minimum step size of 1 pm is measured, with the results shown in FIG. 6A. It is evident that disclosed PIC OFD is more than sufficient to resolve the 1 pm steps. More importantly, it can even detect the transient dynamics when the wavelength steps from one wavelength to another, with the overshoots and settling down processes clearly displayed. In addition, the deviations of wavelength step sizes from the setting step of 1 pm can be clearly observed, which fluctuate between 0.74 pm and 1.76 pm due to the imperfections of the tunable laser, as shown by the measured step sizes in FIG. 6A.

To demonstrate the even finer OFV measurement capability of the disclosed PIC OFD, the same NKT fiber laser used for FIG. 5D with a much finer frequency tuning range is used to generate the required OFV for the PIC OFD to measure, with the result shown in FIG. 6B. The laser is set at the sinusoidal frequency modulation mode with a modulation frequency of 1 Hz and a modulation depth of 10%. The same DAQ card used in FIG. 3 is also used here. As can be seen in FIG. 6B, OFVs with an amplitude of 10 MHz (0.08 pm) can be clearly measured at a measurement bandwidth of 50 Hz and a frequency resolution on the order of 2 MHz (0.016 μm) can be discerned at a detection bandwidth of 5 Hz. The measurement of higher speed OFVs requires higher bandwidth, which may compromise the frequency measurement resolution due to increased noise level, as will be discussed in more detail in the last section.

### PIC OFD for FBG Interrogation

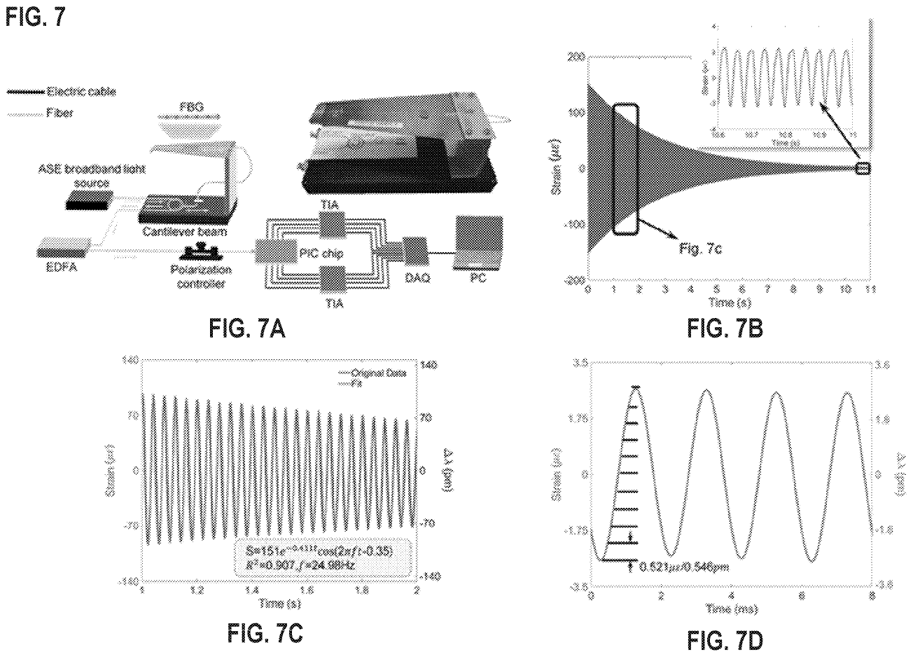

The high resolution and high-speed OFV detection capability of the PIC OFD can be utilized to interrogate fiber Bragg grating (FBG) sensors^{30,37,38}, as will be demonstrated in this section. FIG. 7A shows the experiment setup, which includes an ASE broadband light source, an optical circulator, and an FBG mounted on a self-made cantilever beam with adhesives. The reflected light from the FBG is amplified by an erbium doped fiber amplifier (EDFA) before entering the PIC OFD. The FBG has reflection bandwidth of 0.26 nm (corresponding to a coherence length of 9.2 mm), with a strain sensitivity of 1.048 pm/με, calibrated with a strain sensor.

In operation, the center wavelength of the reflected light from the FBG changes linearly with the strain applied to the FBG³⁹ via the cantilever beam, which can be detected by the PIC OFD with the same low cost DAQ card (60 kS/s and 16-bit resolution) used in FIG. 3. The strain can be obtained from the amount of center wavelength shifts using the strain sensitivity of 1.048 pm/με. FIG. 7B shows the dynamic strain variation with time when the cantilever beam is tapped by fingertip. The damped oscillation of the cantilever beam can be clearly seen, which can be fitted to a typical damped oscillation function with a time constant of 0.411/s and a resonant frequency of 24.98 Hz, as shown in FIG. 7C. The oscillation lasted more than 12 seconds before it was too small to be detected, with the zoom-in strain oscillation data from 10.6 to 11 seconds displayed in the inset of FIG. 7B. FIG. 7C is the expanded view of the data in FIG. 7B marked with the red box, showing the details of the damped strain oscillation.

To further demonstrate the measurement sensitivity and speed of the disclosed PIC OFD, a small speakerphone (Yealink CP700 with a frequency range of 150 Hz~8 kHz) was placed underneath the cantilever beam, which was driven by a 500 Hz sinusoidal signal from a smart phone. The detected dynamic strain is shown in FIG. 7D, which has a strain variation amplitude of 2.1με and a frequency of 500 Hz, consistent with the driving signal. A strain resolution on the order of 0.1~0.2με at 500 Hz can be discerned from FIG. 7D, which is an order of magnitude finer than the best commercial FBG interrogators, as will be shown discussed in the Summary and Discussion section below.

### Features of Demonstrated On-Chip Optical Frequency Detector (OFD)

The demonstrated photonic integrated sine-cosine optical frequency detector includes a pair of unbalanced I-Q interferometers: a main interferometer having a small FSR (or large OPD) and an assistive interferometer with large FSR (or small OPD). The main interferometer is for achieving high resolution, while the assistive interferometer is for estimating the absolute frequency or wavelength, which in turn is used to estimate the absolute wavelength and determine the wavelength dependent parameters for the main interferometer.

The device is realized on the TFLN platform with the large OPD of only 10 mm and a total size of 5.5 mm×2.7 mm, which is shown to be able to measure OFVs down to 2 MHz (0.016 pm) at 5 Hz, limited by the excessive electronic circuit noise in the disclosed OFD measurement system. Such a fine resolution enabled us to see and quantify minor frequency scan imperfections, such as ripples, overshoots, and nonlinearities, which otherwise could not be detected or even noticed with other measurement methods. With a data acquisition rate of 62.5 MS/s, we demonstrated the accurate measurement of frequency (wavelength) variation speed up to 2500 THz/s (20000 nm/s), limited by the achievable laser wavelength scan rate. The minor frequency scan details at such high speed, such as the scanning steps and scanning rate irregularities, can also be clearly detected and quantified. All the frequency (wavelength) scanning characteristics of tunable lasers, including the direction, periodicity, scanning waveforms, scanning rates, nonlinearity, ripples, and repeatability can be accurately determined in the wavelength range of 160 nm from 1480 nm to 1640 nm. The superb performances are ensured by the robust mathematics and associated calibration procedures we developed, which fully accounts for the wavelength dependent imperfections of the device resulting from the design and fabrication tolerances and makes it feasible for being widely adopted in real world applications.

As discussed in^{19,40}, the OFV resolution of the disclosed PIC OFD may be limited by either the resolution of the DAQ card or the detector noise (including the thermal, shock, and electronic noises), whichever is larger, which can be written as¹⁹:

$$δ {f}_{D A Q} = \frac{F S {R}_{u} / 2}{{2}^{m}} = \frac{1}{{τ}_{u} {2}^{m + 1}} \qquad ( 7 a )$$

$$δ {f}_{n} = \frac{F S {R}_{u} / 2}{{V}_{p p} / δ {V}_{n}} = \frac{1}{2 {τ}_{u} S N {R}_{V}} = \frac{1}{2 {τ}_{u} \sqrt{S N {R}_{P}}} = \frac{1}{2 {τ}_{u}} \sqrt{\frac{{ρ}_{n} B}{{P}_{s}}} \qquad ( 7 b )$$

where δf_{DAQ} and δfₙ are the OFV resolution limited by the DAQ card and the system noise, respectively, m is the effective bit number of the DAQ card, Vₚₚ is the peak-peak voltage of the circuit output, δVₙ is the voltage noise, B is the bandwidth of the detector circuitry, including the PD and TIA, ρₙ is the noise power spectral density, Pₛ is the signal power, and SNR_{V} and SNR_{P} are the voltage and power signal to noise ratios (SNR), respectively.

On the other hand, the measurable OFV speed or chirp rate σₘₐₓ is limited by the sampling rate Rₛ of the DAQ card used, which can be written as¹⁹:

$${σ}_{max} = \frac{{R}_{s}}{2 {τ}_{u}} = \frac{B}{{τ}_{u}} = B \cdot {FSR}_{u} \qquad ( 8 )$$

where Rₛ=2B is taken. Combining the two equations yields the OFV detection resolution δfₙ corresponding to the required OFV measurement speed σₘₐₓ:

$$δ {f}_{n} = \frac{1}{2} \sqrt{\frac{( {ρ}_{n} / {τ}_{u} ) {σ}_{max}}{{P}_{s}}} = \frac{1}{2} \sqrt{\frac{( {ρ}_{n} \cdot {FSR}_{u} ) {σ}_{max}}{{P}_{s}}} = \frac{1}{2} \sqrt{\frac{{σ}_{max}}{{SNR}_{P}^{′}}} \qquad ( 9 )$$

where

$${SNR}_{P}^{′} = \frac{{P}_{s}}{{ρ}_{n} \cdot {FSR}_{u}}$$

is the power SNR in the bandwidth of the FSR of the upper (main) interferometer. Clearly, the OFV resolution due to the noise is limited by the required OFV detection speed σₘₐₓ and the SNR in the bandwidth of the FSR of the main unbalanced I-Q interferometer.

TABLE 1
Limits of OFV measurement speeds and resolutions
at different detection bandwidths

| | OFV Resolution δf | | | | | |
|---|---|---|---|---|---|---|
| | σₘₐₓ | 16-bit | Fundamental | | Commercial | |
| Detection | THz/s | DAQ | noises | | electronics | |
| BW (Hz) | (nm/s) | (δf_{DAQ}) | δfₙ (δVₙ) | | δfₙ^{′} (δVₙ^{′}) | |
| 500M | 1.5 × 10⁷ | 0.458 | 1.09 MHz | (0.29 mV) | 6.49 MHz | (1.73 mV) |
| | (1.2 × 10⁸) | MHz | | | | |
| 100M | 3 × 10⁶ | | 0.49 MHz | (0.13 mV) | 3.41 MHz | (0.91 mV) |
| | (2.4 × 10⁷) | | | | | |
| 10M | 3 × 10⁵ | | 153 kHz | (40.8 μV) | 1.13 MHz | (0.3 mV) |
| | (2.4 × 10⁶) | | | | | |
| 1M | 3 × 10⁴ | | 48.4 kHz | (12.9 μV) | 0.37 MHz | (0.1 mV) |
| | (2.4 × 10⁵) | | | | | |

Table 1 lists the theoretically achievable OFV detection speeds σₘₐₓ, the resolutions δf_{DAQ} limited by the DAQ card resolution, the resolution δfₙ limited by fundamental noises, and the resolution

$$δ {f}_{n}^{′}$$

limited by the noises or a commercial available electronics (PD, TIA and DAQ card) at different detection bandwidths, for the disclosed PIC OFD having an FSR of 30 GHz. In the calculation, the TIA is assumed to have an output voltage range of 4.0 volts and the DAQ card is assumed to have an effective resolution of 15-bits capable of digitizing voltages in a range of 4 volts. As can be seen from Table 1, for a perfect electronic circuit with fundamental noise levels (δVₙ in parentheses), the OFV resolution is 458 kHz when detection bandwidths less than 100 MHz, determined by the resolution of the DAQ card. Above 100 MHz detection bandwidth, the OFV resolution is determined by the fundamental noise, at 490 KHz and 1.09 MHz, corresponding to detection bandwidths of 100 MHz and 500 MHz, respectively. However, in practice it is difficult if not impossible for the electronic noises to be lowered to the fundamental noise levels. The last column of Table 1 lists the OFV detection resolution

$$δ {f}_{n}^{′}$$

limited by the noise levels

$$( δ {V}_{n}^{′}$$

in parentheses) of a commercial photodetector with TIA (Thorlabs' PBD470C) measured with an oscilloscope (Rohde & Schwarz RTB2004). At a detection bandwidth of 1 MHz or less, the OFV detection resolution is 458 kHz, determined by the DAQ card with an effective resolution of 15-bit. At a detection bandwidth of more than 1 MHz, the OFV detection resolution is determined by the electronics noise levels

$$δ {V}_{n}^{′} .$$

TABLE 2
Performance comparison of different FBG interrogators

| | Wavelength | | Strain | | Temperature | |
|---|---|---|---|---|---|---|
| Brand and Model | resolution | | resolution | | resolution | |
| Geokon Instrument | 3 | pm | 2.5 | με | 0.27° | C. |
| BGK-FBG8600L | | | | | | |
| Luna ODISL B | 1.5 | pm | 1.25 | με | 0.135° | C. |
| FBGS FBG-Scan 90X | 0.3 | pm | 0.25 | με | 0.027° | C. |
| PIC AWG interrogator ⁴ | 2 | pm | — | | — | |
| PIC active modulation | 0.0873 | pm | — | | — | |
| interrogator ³⁷ | | | | | | |
| PIC sine-cosine OFD | 0.016 | pm | 0.013 | με* | 0.0015° | C.* |
| (at 5 Hz BW) | | | | | | |

| | | | | | |
|---|---|---|---|---|---|
| PIC sine-cosine OFD | 0.0037 | pm | 0.003 | με | 0.34 × 10⁻³° C. |
| (16-bit ADC limit)** | | | | | |

*Calculated with the wavelength resolution of 0.016 pm (circuit noise limited results).
**Wavelength resolution calculated using Eq. (7a), assuming a 16-bit DAQ with 15 bits effective resolution.

As an application example, the disclosed sine-cosine PIC OFD can be used as a high speed and high resolution FBG interrogator, with a strain measurement resolution of 0.1~0.2με at 500 Hz. Corresponding to the wavelength resolution of 0.016 pm at 5 Hz measurement bandwidth, the calculated strain and temperature resolution are 0.013με and 0.0015° C., respectively, which is about 20 times more sensitive than those of the best commercial interrogators, as shown in Table 2, and can be used to measure the dynamic strain variations induced by vibrations and acoustics with high sensitivity. Even better strain and temperature resolution can be achieved if the OFV resolution of the disclosed PIC OFD can be improved by reducing the circuit noise to the level achievable with commercial electronics. As indicated in Table 1, for a detection bandwidth up to 1 MHz (corresponding to an ultra-high OFV detection speed σₘₐₓ of 3×10⁴ THz/s), the OFV resolution is limited by the resolution of the 16-bit DAQ card (with 15-bit effective resolution) to be 458 kHz (0.0037 pm), corresponding to a strain and temperature resolutions of 0.003με and 0.34×10⁻³° C., respectively, as shown in the last row of Table 2, which are over 80 times more sensitive than those of the best commercial FBG interrogators.

The present PIC OFD suffers from high insertion loss and high wavelength dependent loss, mostly due to the grating coupler used for attaching the input fiber, which can be improved significantly using edge coupling with a properly designed spot size converter. Much finer OFV resolution can be achieved with longer OPD in the main I-Q interferometer if required, possibly on the SiN platform with lower waveguide transmission loss.

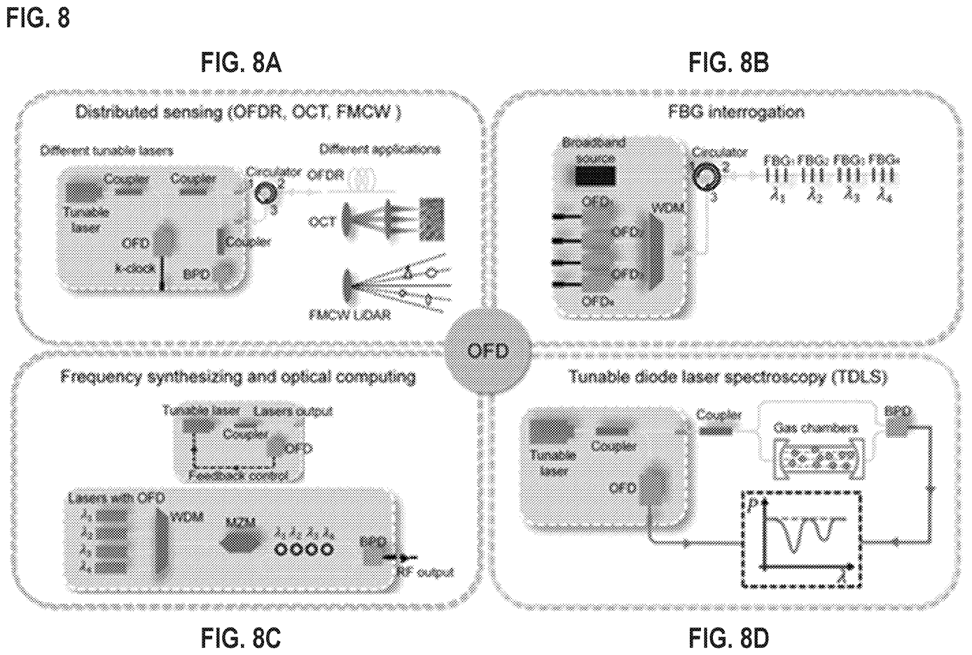

The disclosed PIC OFD and the associated robust demodulation algorithm point to a fruitful direction for the on-chip OFV measurement with high resolution, high speed and wide wavelength range, which is attractive for on-chip laser frequency control or stabilization, photonic computing, FBG interrogation, in addition to the k-clock generation on the PIC chips for OFDR, OCT, FMCW Lidar, and TDLS applications, as depicted in FIG. 8.

### Device Design and Fabrication

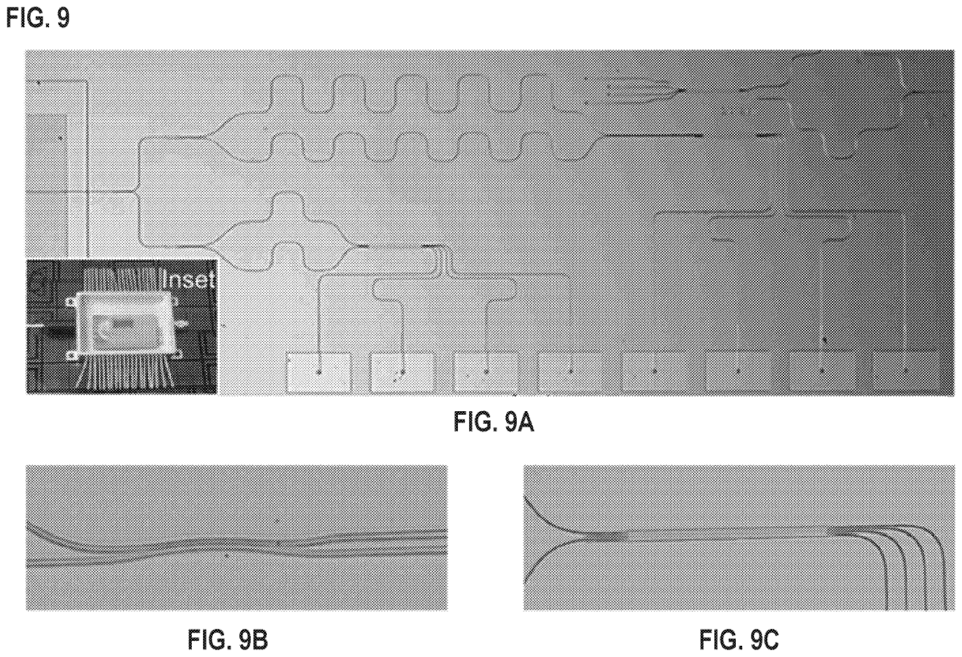

The proposed device was fabricated using an x-cut LNOI wafer, which implements a 360-nm-thick X-cut LN layer and a 4.7-μm-thick buried oxide layer. FIG. 9A presents a micrograph of the fabricated device. It includes an edge coupler, three 3-dB 2×2 bend-directional couplers (BDCs), two 90° hybrids, and eight photodetectors to form the upper and lower interferometers. The enlarged micrographs of the 3-dB 2×2 BDC and the 90° hybrid can be found in FIGS. 9B and 9C, respectively. The OPDs for the two interferometers are designed to be 10 mm and 14.43 μm, corresponding to a FSR of 30 GHz and 20.79 THz (169.3 nm), respectively. The inset shows the packaged device in a butterfly enclosure with a thermal electric cooler (TEC), which was set at 30° C. for normal operation to avoid OPD variations due to temperature changes.

The fabrication process is simple and straightforward, which will be described in the Supplementary Information Section. Such a simple fabrication process ensures that the device can be mass produced with high yield at low cost.

### Supplementary Information Section

This section provides additional technical information of the disclosed technology.

### I. Upper (Main) I-Q Interferometer Calibration

As described in Device Calibration subsection, the fabricated device is not perfect, with many parameters deviating from ideal values and wavelength dependent, which must be obtained by calibration at different wavelengths. The setup for calibrating and evaluating the sine-cosine PIC OFD is shown in FIG. 2. The circuit bias Aᵤⱼ in Eq. (1) can be obtained by simply turning the laser off. By scanning the laser frequency in the vicinity of λ with a range larger than FSRᵤ (the FSR of the upper or main I-Q interferometer), four interference signals

$${V}_{u j}^{′} ( t )$$

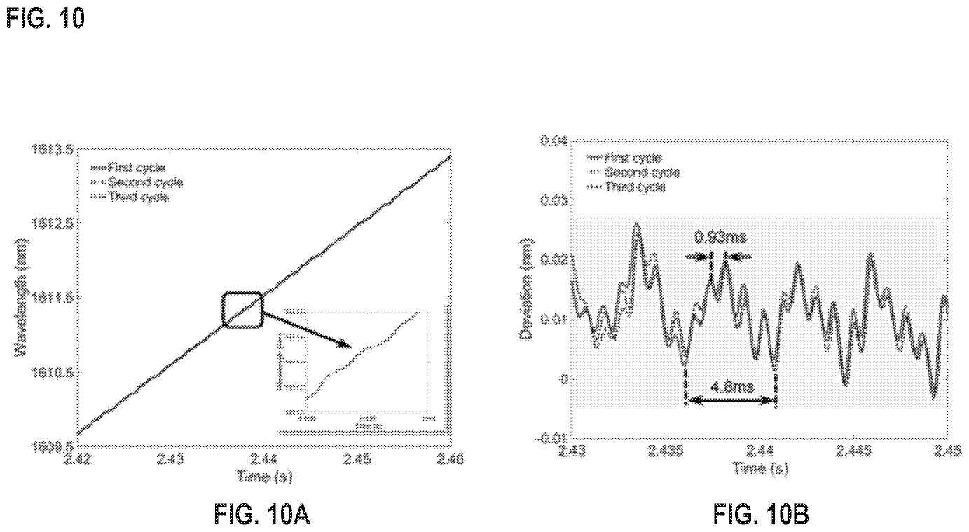

(j=1, 2, 3, 4) of Eq. (1) can be obtained, as shown in FIG. 10A for λ=1519 nm, where

$${V}_{u j}^{′} ( ‡ j ) = {V}_{u j} ( t ) - {A}_{u j} .$$

By plotting the Lissajous figures of

$${V}_{u 1}^{′} ( t ) vs . {V}_{u 3}^{′} ( t ) , {V}_{u 2}^{′} ( t ) vs . {V}_{u 3}^{′} ( t ) , and {V}_{u 1}^{′} ( t ) vs . {V}_{u 4}^{′} ( t ) ,$$

and finally performing the elliptical fits of these three Lissajous figures, all the wavelength dependent parameters (Aᵤⱼ, Bᵤⱼ, mᵤⱼBᵤⱼ, αᵤ, βᵤ, γᵤ) at Δ=1519 nm can be obtained. FIG. 10B shows an example of plotting

$${V}_{u 1}^{′} ( t ) vs . {V}_{u 3}^{′} ( t )$$

and performing elliptical fit, with which Bᵤ₁=1.0958 V, Bᵤ₃=0.9177 V, mᵤ₁=0.976, mᵤ₃=0.95, and

$${γ}_{u} - \frac{{β}_{u}}{2} + \frac{{α}_{u}}{2} = 2.659 °$$

are obtained. By completing the remaining two elliptical fits, αᵤ, βᵤ, γᵤ and Bᵤ₃ can be obtained.

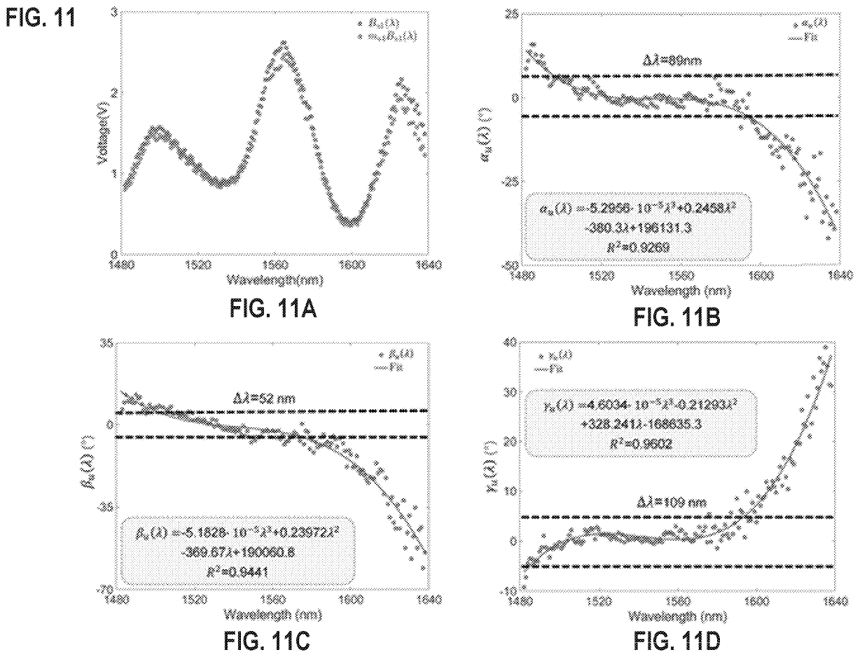

By stepping the wavelength λ every 1 nm, a lookup table of (Aᵤⱼ, Bᵤⱼ, mᵤⱼBᵤⱼ, αᵤ, βᵤ, γᵤ) vs. λ can be obtained, as shown in FIG. 11, which can be used to calculate the OFVs of unknown light sources using Eq. 4(c). FIG. 11A shows the obtained wavelength responses of Bᵤ₁(λ) and mᵤ₁Bᵤ₁(λ) at a wavelength step of 1 nm. Their large variations vs. wavelength are mainly due to the grating couplers for coupling light into the OFD chip, which can be improved with better coupling designs. Similar results can be obtained for j=2, 3, 4.

FIGS. 11B, 11C, and 11D are the wavelength responses of phase imperfections αᵤ(λ), βᵤ(λ), and γᵤ(λ) obtained from the elliptical fits of the Lissajous figures. As can be seen, they are near zero in the vicinity of the design wavelength 1550 nm and increase significantly beyond 1580 nm. The bandwidths corresponding to +5° phase deviation for αᵤ(λ), βᵤ(λ), and γᵤ(λ) are 89 nm, 52 nm, and 109 nm, respectively, with much large phase deviations outside of these bandwidths. Fortunately, these large imperfections are already accounted for in Eq. (4c) such that they will not impact the accuracies of the Δf(t) calculation if their values are determined by calibration. As discussed previously, these five parameters, together with the circuit bias Aᵤⱼ, are stored in the lookup table to be called out when calculating the frequency variation Δf(t) using Eq. (4c) if the wavelength is approximately known.

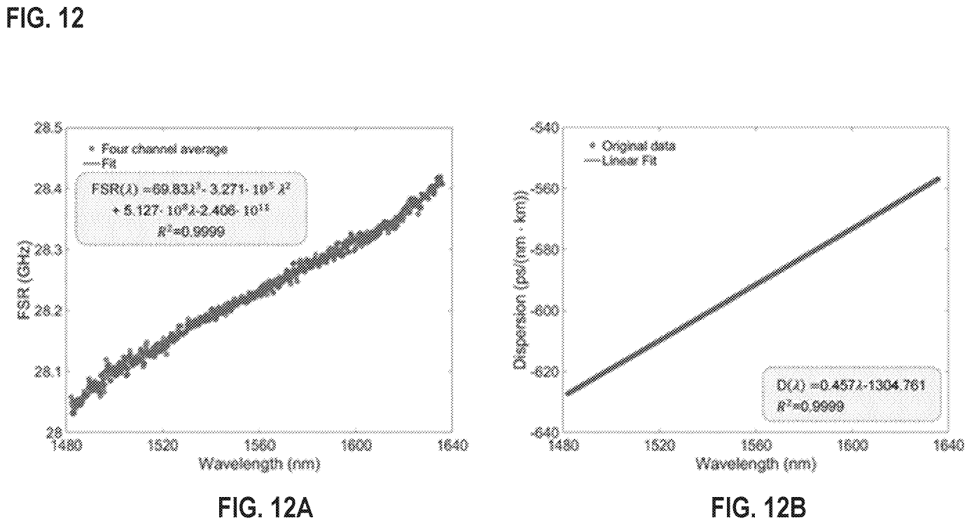

As mentioned in the discussions below Eq. (3), in addition to the parameters obtained above, the free spectral range FSR of the upper I-Q interferometer is also wavelength dependent due to the dispersion of the TFLN waveguide, which can be obtained using the setup of FIG. 2 by scanning the wavelength of the tunable laser from 1480 to 1640 nm while recording the four sinusoidal interference signals of the upper interferometer. With some data processing, the FSR at each wavelength is taken as the average periodicity of the four sinusoidal signals, as shown in FIG. 12A, which can be used to obtain the corresponding dispersion coefficient, as shown in FIG. 12B.

### II. Lower (Assistive) I-Q Interferometer Calibration

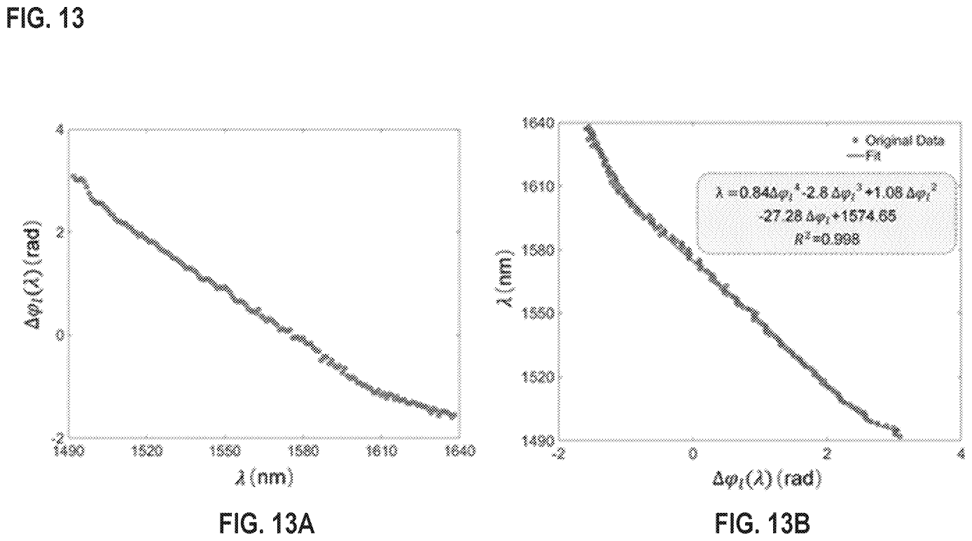

As discussed above, the lower or the assistive interferometer can be used to determine the absolution wavelength λ or frequency of unknown light sources from the lookup table of Δφₗ vs. λ obtained from calibration. Like the calibration of the upper or the main interferometer, the four photocurrent outputs of the lower interferometer with a large FSR (FSRₗ) are converted into four voltages Vₗⱼ(t) (j=1, 2, 3, 4) by another 4-channel transimpedance amplifier before being digitized by the DAQ card as the wavelength of the calibration laser is scanned using the setup of FIG. 2. The circuit bias Aₗⱼ can be obtained by turning the laser off. Because all the components used in the lower interferometer, including the 1×2 coupler and the 2×4 MMI, are identical in design and fabrication to those in the upper or main interferometer, each of the parameters αₗ(λ), βₗ(λ), γₗ(λ) in Eq. (5) should be the same as the corresponding parameter αᵤ(λ), βᵤ(λ), γᵤ (λ), respectively. In addition, Bₗⱼ(λ) should have the same wavelength response as Bᵤⱼ (λ), except that they may differ from each other by a constant factor which can be determined experimentally. Finally, mₗⱼ and mᵤⱼ are also expected to be the same. Therefore, one may use the same parameters obtained for the upper interferometer in Eq. (5) to calculate the phase Δφₗ(λ) using Vₗⱼ(t) (j=1, 2, 3, 4) at different λ, as shown in FIG. 13A, which can be stored in the lookup table of Δφₗ vs. λ to be called out later when calculating the frequency or wavelength with the upper interferometer using Eq. (4c). For convenience, the corresponding λ vs. Δφₗ can be obtained, as shown in FIG. 13B, which can be fitted to a 4^{th} order polynomial function. Either the lookup table or the fitted function can be used in practice to get the value of λ from a measured Δφₗ.

### III. Device Fabrication

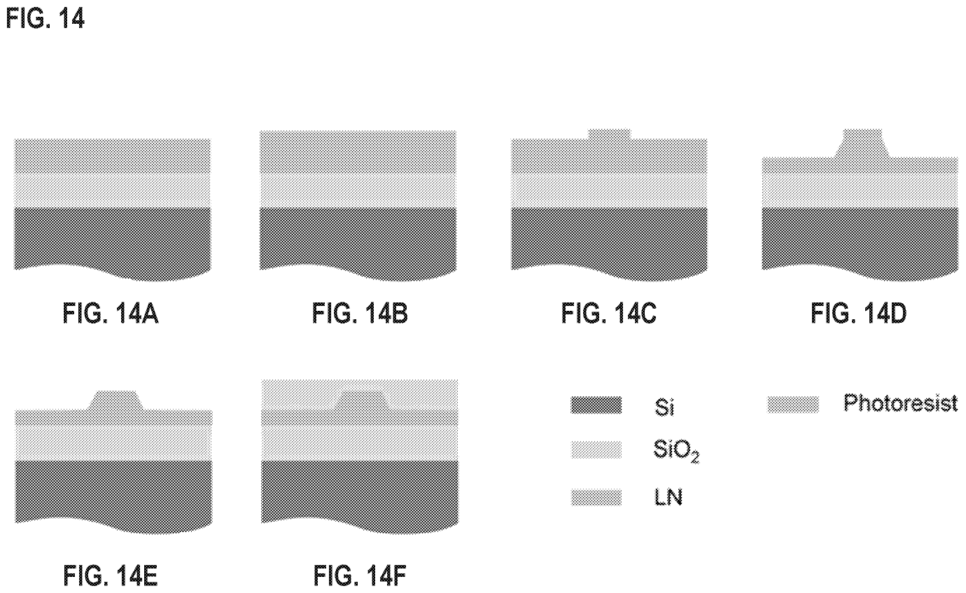

FIG. 14 includes FIGS. 14A through 14F and presents an example of a fabrication process of the disclosed PIC OFD devices using an x-cut lithium niobate thin film on insulator LNOI wafer (NANOLN), which includes a 360-nm-thick X-cut lithium niobate LN layer and a 4.7-μm-thick buried insulator layer (e.g., SiO₂). The fabrication process is detailed below: FIG. 14A: Clearing the wafer; FIG. 14B: Spin coating the LN film with photoresist; FIG. 14C: Patterning the waveguide layer with deep ultraviolet (DUV) lithography; FIG. 14D: Etching the LN film; FIG. 14E: Removing the photoresist; FIG. 14F: depositing SiO₂ layer on the surface of the LN film.

The disclosed optical frequency detectors based on on-chip real-time detection of optical frequency variations with ultrahigh resolutions can be implemented to include various components and/or features, including various features disclosed in
(1) U.S. Pat. No. 11,619,783 entitled “Sine-cosine optical frequency detection devices for photonics integrated circuits and applications in LiDAR and other distributed optical sensing” by Xiaotian Steve Yao, and
(2) U.S. patent application publication No. US20230236295A1 entitled “Sine-cosine optical frequency detection devices for photonics integrated circuits and applications in lidar and other distributed optical sensing” by Xiaotian Steve, which are incorporated by reference as part of the disclosure of this patent document.

Only a few implementations and examples are described and other implementations, enhancements and variations can be made based on what is described and illustrated in this patent document.

### REFERENCES

1. Wu, Y., Deng, L., Yang, K. & Liang, W. Narrow linewidth external cavity laser capable of high repetition frequency tuning for FMCW LiDAR. IEEE Photonics Technol. Lett. 34, 1123-1126 (2022).
2. Ding, Z. et al. Compensation of laser frequency tuning nonlinearity of a long range OFDR using deskew filter. Opt. Express 21, 3826-3834 (2013).
3. Ding, Z. et al. Note: Improving spatial resolution of optical frequency-domain reflectometry against frequency tuning nonlinearity using non-uniform fast Fourier transform. Rev. Sci. Instrum. 83, (2012).
4. Chen, Z. et al. Fully integrated on-chip FBG interrogator for high-accuracy measurement of wavelengths. Opt. Lett. 48, 5935-5938 (2023).
5. Feldmann, J., Youngblood, N., Wright, C. D., Bhaskaran, H. & Pernice, W. H. All-optical spiking neurosynaptic networks with self-learning capabilities. Nature 569, 208-214 (2019).
6. Tait, A. N. et al. Neuromorphic photonic networks using silicon photonic weight banks. Sci. Rep. 7, 7430 (2017).
7. Tait, A. N., De Lima, T. F., Nahmias, M. A., Shastri, B. J. & Prucnal, P. R. Multi-channel control for microring weight banks. Opti. Express 24, 8895-8906 (2016).
8. Tait, A. N. et al. Feedback control for microring weight banks. Opt. Express 26, 26422-26443 (2018).
9. Alkhazraji, E., Chow, W. W., Grillot, F., Bowers, J. E. & Wan, Y. Linewidth narrowing in self-injection-locked on-chip lasers. Light Sci. Appl. 12, 162 (2023).
10. Guo, J. et al. Chip-based laser with 1-hertz integrated linewidth. Sci. Adv. 8, eabp9006 (2022).
11. Xiang, C., Morton, P. A. & Bowers, J. E. Ultra-narrow linewidth laser based on a semiconductor gain chip and extended Si₃N₄ Bragg grating. Opt. Lett. 44, 3825-3828 (2019).
12. Xiang, C. et al. Narrow-linewidth III-V/Si/Si₃N₄ laser using multilayer heterogeneous integration. Optica 7, 20-21 (2020).
13. Hall, J. L. Laser Spectroscopy III. (Springer Berlin, Heidelberg, 1977).
14. Snyder, J. Laser Wavelength Meters. Laser Focus. (1982).
15. Gardner, J. L. Compact Fizeau wavemeter. Appl. Opt. 24, 3570-3573 (1985).
16. Gray, D. F., Smith, K. A. & Dunning, F. B. Simple compact Fizeau wavemeter. Appl. Opt. 25, 1339-1343 (1986).
17. Derickson, D. a. S. et al. in Fiber optic test and measurement (ed Dennis Derickson) Ch. 4, (Prentice Hall, 1998).
18. Vobis, J. a. D. et al. in Fiber optic test and measurement (ed Dennis Derickson) Ch. 3, (Prentice Hall, 1998).
19. Yao, X. S. & Ma, X. S. Sine-Cosine Techniques for Detecting Fast Optical Frequency Variations With Ultra-High Resolution. J. Lightwave Technol. 41, 1041-1053 (2023).
20. Moore, E. D. & McLeod, R. R. Correction of sampling errors due to laser tuning rate fluctuations in swept-wavelength interferometry. Opt. Express 16, 13139-13149 (2008).
21. Ahn, T.-J., Lee, J. Y. & Kim, D. Y. Suppression of nonlinear frequency sweep in an optical frequency-domain reflectometer by use of Hilbert transformation. Appl. Opt. 44, 7630-7634 (2005).
22. Ahn, T.-J. & Kim, D. Y. Analysis of nonlinear frequency sweep in high-speed tunable laser sources using a self-homodyne measurement and Hilbert transformation. Appl. Opt. 46, 2394-2400 (2007).
23. Yao, X. S., Zhang, B., Chen, X. & Willner, A. E. Real-time optical spectrum analysis of a light source using a polarimeter. Opt. Express 16, 17854-17863 (2008).
24. Yao, X. S. & Chen, X. J. Sine-cosine optical frequency encoder devices based on optical polarization properties.). U.S. Pat. No. 10,895,477 (2021).
25. Yao, X. S., Ma, X. & Feng, T. Fast optical frequency detection techniques for coherent distributed sensing and communication systems. In: 2022 Optical Fiber Communications Conference and Exhibition (OFC)). IEEE (2022).
26. Kim, J.-C., Kim, J.-M., Kim, C.-U. & Choi, C. Ultra precise position estimation of servomotor using analog quadrature encoders. In: Twenty-First Annual IEEE Applied Power Electronics Conference and Exposition, 2006. APEC'06.). IEEE (2006).
27. Jenkins, S. T. & Hilkert, J. Sin/cosine encoder interpolation methods: encoder to digital tracking converters for rate and position loop controllers. In: Acquisition, Tracking, Pointing, and Laser Systems Technologies XXII). SPIE (2008).
28. Xiang, C. et al. Integrated chip-scale Si₃N₄ wavemeter with narrow free spectral range and high stability. Opt. Lett 41, 3309-3312 (2016).
29. Stern, B., Kim, K., Gariah, H. & Bitauld, D. Athermal silicon photonic wavemeter for broadband and high-accuracy wavelength measurements. Opt. Express 29, 29946-29959 (2021).
30. Yao, X. S. Sine-cosine optical frequency detection devices for photonics integrated circuits and applications in lidar and other distributed optical sensing.). U.S. Pat. No. 11,619,783 B2 (2023).
31. Tan, H. et al. C-Band optical 90-degree hybrid using thin film lithium niobate. Opt. Lett. 48, 1946-1949 (2023).
32. Faralli, S. et al. A compact silicon coherent receiver without waveguide crossing. IEEE Photonics Journal 7, 1-6 (2015).
33. Lee, S. Y. et al. Cost-effective 400-Gbps micro-intradyne coherent receiver using optical butt-coupling and FPCB wirings. Opt. Express 26, 28453-28460 (2018).
34. Seimetz, M. & Weinert, C.-M. Options, feasibility, and availability of 2×4 90° hybrids for coherent optical systems. J. lightwave Technol. 24, 1317 (2006).
35. Zhang, J. et al. Compact low-power-consumption 28-Gbaud QPSK/16-QAM integrated silicon photonic/electronic coherent receiver. IEEE Photonics Journal 8, 1-10 (2016).
36. Soldano, L. B. & Pennings, E. C. Optical multi-mode interference devices based on self-imaging: principles and applications. J. lightwave Technol. 13, 615-627 (1995).
37. Marin, Y. E., Nannipieri, T., Oton, C. J. & Pasquale, F. D. Current status and future trends of photonic-integrated FBG interrogators. J. lightwave Technol. 36, 946-953 (2018).
38. Elaskar, J. et al. Ultracompact microinterferometer-based fiber Bragg grating interrogator on a silicon chip. J. lightwave Technol. 41, 4397-4404 (2023).
39. Abushagur, A. A., Arsad, N. & Bakar, A. A. A. Cantilever beam with a single fiber bragg grating to measure temperature and transversal force simultaneously. Sensors 21, 2002 (2021).
40. Ma, X. & Yao, X. S. Single-frequency lasers' linewidths elegantly characterized with Sigmoid functions of observation time. J. lightwave Technol. 42, 4569-4584 (2024).

What is claimed is what is described and/or illustrated, including:

1. A device for measuring an optical frequency of light, comprising:
a substrate fabricated to support an integrated optical frequency detector to receive input light for measuring an optical frequency of the received input light;
a first optical interferometer formed on the substrate having two interfering optical arms and an input optical port to receive a first portion of the received input light at an input optical wavelength that is split into the two interfering optical arms and an output optical port to receive and combine light from the two interfering optical arms to produce two first optical output interferometer signals,
a second optical interferometer formed on the substrate having two interfering optical arms and an input optical port to receive a second portion of the received input light which is split into the two interfering optical arms, and an output optical port to receive and combine light from the two interfering optical arms to produce two second output interferometer signals, wherein the second optical interferometer is structured to have a phase difference between the two interfering arms different from a phase difference between the two interfering arms of the first optical interferometer;
photodetectors formed on the substrate to detect output signals from the first and second optical interferometers to obtain signal variations as both a sine function of an optical frequency of the input light and a cosine function of the optical frequency of the input light; and
circuitry coupled to receive the output signals from the first and second optical interferometers and configured to process the output signals from the first and second optical interferometers based on the sine and consine functions and additional information of hardware imperfections caused by fabrication of the integrated optical frequency detector by deviations from device designs to determine an optical frequency of the input light.

2. The device as in claim 1, further comprising optical waveguide supported by the substrate to direct light associated with the first and second optical interferometers and the photodetectors.

3. The device as in claim 1, wherein the substrate includes silicon and supports an insulator layer over the substrate and a lithium niobate thin film over the insulator layer.

4. A method for measuring an optical frequency of light, comprising:
using an integrated optical frequency detector formed on a substrate to receive input light for measuring an optical frequency of the received input light, wherein the integrated optical frequency detector include a first optical interferometer formed on the substrate having two interfering optical arms and an input optical port to receive a first portion of input light at an input optical wavelength that is split into the two interfering optical arms and an output optical port to receive and combine light from the two interfering optical arms to produce two first optical output interferometer signals, and a second optical interferometer formed on the substrate having two interfering optical arms and an input optical port to receive a second portion of the input light which is split into the two interfering optical arms, and an output optical port to receive and combine light from the two interfering optical arms to produce two second output interferometer signals, wherein the second optical interferometer is structured to have a phase difference between the two interfering arms different from a phase difference between the two interfering arms of the first optical interferometer;
detecting output signals from the first and second optical interferometers to obtain signal variations as both a sine function of an optical frequency of the input light and a cosine function of the optical frequency of the input light; and
processing the output signals from the first and second optical interferometers based on the sine and consine functions and additional information of hardware imperfections caused by fabrication of the integrated optical frequency detector by deviations from device designs to determine an optical frequency of the input light.

5. The method as in claim 4, wherein the processing for determination of the optical frequency of the input light reaches a frequency resolution less than 10 MHz.

6. The method as in claim 5, wherein the processing for determination of the optical frequency of the input light reaches a frequency resolution around 2 MHz.

7. The method as in claim 4, wherein the processing of the output signals from the first and second optical interferometers is at a high speed to measure the optical frequency of the input light whose optical frequency varies above 1000 THz per second.
